(19) United States
(12) Patent Application Publication
(10) Pub. No.: US 2004/0168788 A1
(43) Pub. Date: Sep. 2, 2004

(54) Riser(s) size reduction and/or metal quality improving in gravity casting of shaped products by moving electric arc

(76) Inventors: Pavel Dvoskin, Sfarim (IL); Valery Zlochevsky, Netanya (IL); Dror Nadam, Eyn-Sarid (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/484,200

(22) PCT Filed:
(86) PCT No.: PCT/IL02/00584

(30) Foreign Application Priority Data
Jul. 18, 2001 (IL) 144422

(51) Int. Cl. B22C 9/08; B22D 27/04; B22D 27/06

(52) U.S. Cl. 164/359; 164/124; 164/514

(57) ABSTRACT

The invention invention provides an apparatus (10) and a method for reducing the volume of risers, and for the possibility of reducing shrinkage blowhole and porosity in shaped gravity casting. The invention provides an apparatus (10) for producing metal flow/stir in the liquid metal (31), the apparatus (10) comprising at least one electrode (16) for forming a continuously-moving plasma arc (34) over the upper surface of selected riser(s) (12) in metallic casting being cast, a stand (26) for suspending said plasma arc electrode (16) over the upper surface of said risers (12) during the casting process, a second electrode (28) attachable to the liquid metal (31) or the metal being used for casting and a power supply (36) for completion of an electric circuit including said plasma arc (34); and control means (38) connected between said apparatus (10) and said power supply (36).

### FIELD OF THE INVENTION

The present invention relates to improvements in the casting of both ferrous and non-ferrous metals.

More particularly, the invention provides an apparatus and a method for reducing the volume of risers, and for the possibility of reducing shrinkage blowhole and porosity here and after defined as “voids” in shaped gravity casting, for example: sands, permanent or semi permanent mold casting. In some cases grain size, porosity and inclusion reduction and better homogeneity and structure can be achieved.

### BACKGROUND OF THE INVENTION

Gravity casting of shaped finished product (GCSP) from metal is most commonly done in sand or permanent or semi-permanent mold casting. The products usually do not subjected to any further plastic processing, except some machining and heat treatment, if needed.

The GCSP is based on casting metals/alloys into a shaped mold by gravity. In sand casting, for example, the mold is made of sand and clay which hardened previous to the casting in a pattern. The mold is disposable/recyclable and should be reproduced for each casting. Complicated shapes are made from several sand cores (some time refer as grains), that are put together to create the pattern. In accordance therewith a permanent mold is usually made out of at least two metal body parts that are joined together to form the pattern. This kind of mold is for multiple use. Semi-permanent molds contain both metal outer body and sand inner cores, and mainly being used for complicated shapes such as cylinder heads.

For manufacturing defect free castings and to compensate for volume shrinkage during the solidification process, several chimney-shape risers are used to create a metalostatic (hydrostatic) pressure to push the liquid metal to the shrinked areas Since the upper part of the casting is the last to solidified and to observes all the shrinkage, a well designed casting will be one that have enough risers to compensate all the shrinkage and defects that occur during the solidification process. The risers have additional role to serves as a reservoir of a liquid metal for compensating shrinkage inside the solidifying body. For example in high quality aluminum or steel castings the weight of the risers can reach the weight of the finished product. At the end of the process the risers are cut off, discarded or remelted.

Obviously, once the metal in the riser has solidified it can no longer serve its purposes. To delay such solidification, some commercially available products have been developed. Ceramic heat-insulating sleeves can help to extend the period of riser liquidity. An exothermic powder can be applied to generate heat on the upper face of the riser, but such powder can cause casting contamination.

Moving an electric arc according to the Invention, for example a circulating arc, acts on the top of all or selected risers, create a sufficient heat to preserve the metal reservoir in the risers molten (for longer period of time), and to produce enough pressure that enables to reduce the risers size by 60%-80%. The moving electric arc which produce liquid metal flow/stir, to compensate for the reduction in potential energy when the risers' height is reduced by 60%-80%.

The electric arc can be produced by a various meanings and electrodes, for example as describe in PCT patent application PCT/IL97/00023. This patent presents various electrode for producing circulating plasma arcs for use in casting.

It is also in the scope of the present invention to be able to increase the quality of the product, mainly to reduce porosity, and grain size, depending on the alloy and the casting. For example cast iron and some aluminum-silicon castings, have low-density areas in the casting due to porosity. In aluminum alloy casting the problem can be solved by using large amount of risers, but in cast iron it is almost inevitable. Applying the process as describe above, can reduce porosity, reduce grain size and improve mechanical properties.

The present invention achieves the above objects by providing an apparatus for producing metal flow/stir in the liquid metal, said apparatus comprising:

a) at least one electrode for forming a continuously-moving plasma arc over the upper surface of selected riser(s) in metallic casting being cast;

b) a stand for suspending said plasma arc electrode over the upper surface of said riser(s) during the casting process;

c) a second electrode attachable to the liquid metal or the mold being used for casting and a power supply, for completion of an electric circuit including said plasma arc; and

d) control means connected between said apparatus and said power supply.

In a preferred embodiment of the present invention there is provided a plasma casting apparatus wherein multiple electrodes are provided, each electrode being positionable over one of the risers of a large casting for producing separate moving plasma arcs over each riser.

In a preferred process of the present invention there is provided a method for reducing riser size and/or reducing voids, inclusions, porosity and grain size in metallic castings and for improving homogeneity therein, said method comprising

step a) casting a molten metal into a mold (the mold include riser(s));

step b) providing plasma arc electrode(s) and positioning same slightly above the upper surface of molten metal in the riser(s); and

step c) connecting an electric potential to said electrode(s) to form a continually moving plasma arc, during the solidification process or part thereof, between said electrode(s) and the upper surface of said riser.

It is to be stressed that the method and apparatus to be described have been tested in practice. The size of the electrode is depended on the size of the risers, and the amount of electrodes required is depended on the geometric complicity of the product been cast. The amount of energy and the duration of the arc treatment also depended on the product. For example, a 10-electrode apparatus for the semi-permanent casting of cylinder heads in accordance with claims 1 and 5 of the present invention has been built and operated to meet the objects of the invention see FIG. 2-3. For electrode with 40 mm diameter an optimum of 0.03 kWh per kg is the most suitable to produce stir/flow, heating and pressure for this semi permanent aluminum cylinder head casting.

An example of riser volume reduction can be seen in FIG. 45.

A sample for porosity reduction in the cylinder head mentioned above can be seen in FIG. 8-9.

A sample for grain refinement in aluminum alloy can be seen in FIG. 10-11. An aluminum part was cast with 2 risers with and without applying moving electric arc on the top of the risers. The conventional casting FIG. 10 has a coarse microstructure with coarse inter dendritic spacing while the treated part FIG. 11 has much finer structure.

2 circulating arcs of 150 Amp each was applied for 120 sec (the entire solidification time).

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a partially-sectioned view of a preferred embodiment of the apparatus according to the invention, showing a semi-permanent mold casting being made;

FIG. 2 is a perspective view of casting manufactured by the use of a 10-electrodes apparatus;

FIG. 3 is a plan view of a 12-electrodes embodiment;

FIG. 4 is a photograph of an aluminum cylinder head of 36 kg casting produced by conventional casting;

FIG. 5 is a photograph of the same aluminum cylinder head as in FIG. 4 of 26 kg casting treated by the method and apparatus of the present invention;

FIG. 6 is side view of a steel casting manufactured by conventional casting;

FIG. 7 is a side view of the same casting as seen in FIG. 6, treated by the method and apparatus of the present invention;

FIG. 8 is a photograph of an aluminium cylinder head slice of 26 kg casting produced by conventional casting;

FIG. 9 is a photograph of the same aluminum cylinder head slice as in FIG. 8 of 26 kg casting treated by the method and apparatus of the present invention;

FIG. 10 is a microstructure photograph of an aluminum alloy casting manufactured by conventional casting; and

FIG. 11 is a microstructure photograph of the same aluminium alloy casting as seen in FIG. 10 treated by the method and apparatus of the present invention.

### DETAILED DESCRIPTION OF THE INVENTION

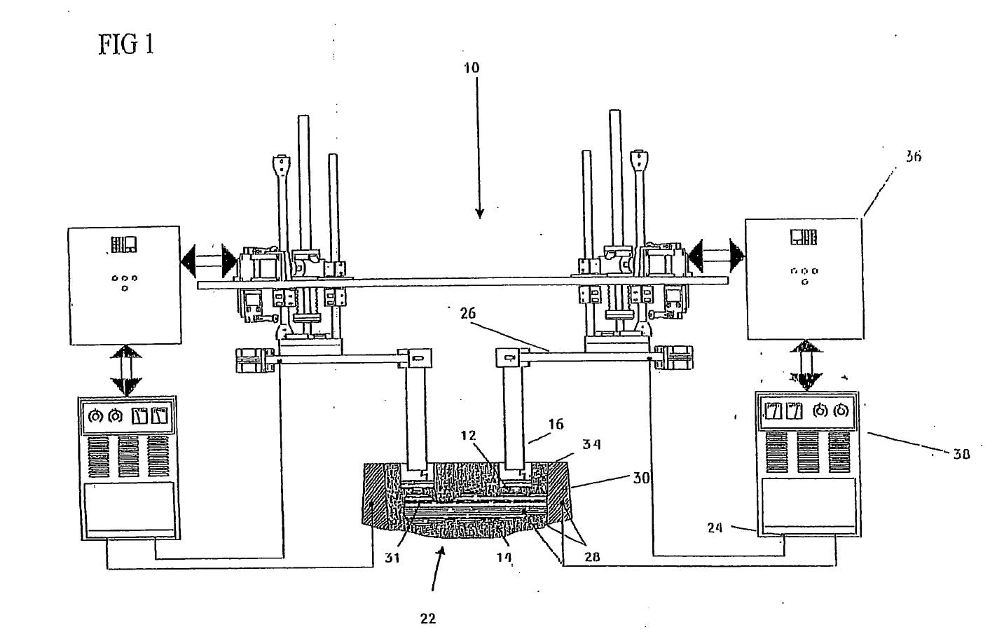

There is seen in FIG. 1 a metal casting apparatus 10 for reducing the size of risers 12 in discrete metal castings, and in some alloys for reducing voids, inclusions, porosity and grain size therein. Also, homogeneity is improved as will be seen in FIG. 11. In the present embodiment a semi permanent mold casting 22 is being treated.

The diagram shows an apparatus 10 carrying two plasma arc first electrodes 16, which are positioned about 2-20 mm above the upper surface of molten metal in risers 12. A terminal 24 is attached to the first electrode 16.

A stand 26 suspends each first electrode 16 as needed.

A second electrode 28 is attached to a metallic surface 30 of the mold 22 being used for casting, or to the molten metal 31 directly. The second electrode 28, connected to the other terminal line, completes an electric circuit passing through molten metal 31 cast in the mold 22 through a plasma arc 34 to be formed between the upper surface of each riser 12 and the lower face of the corresponding first electrode 16.

Electronic control means 36 are provided, for adjusting the electrical parameters, connected to the first and second electrodes 16, 28. Control means 36 are connected to an appropriate power supply 38.

On connection of power to the plasma arc electrodes 16, 28, electric circuits are formed through and by generation of the plasma arcs 34. The gap between the upper surface of the risers 12, and the lower surface of the corresponding first electrode 16, is bridged by the continuously-moving plasma arc 34, which flow/stir the molten metal in the mold 22. The control means 36 connected between the apparatus 10 and the power supply 38 enable an operator to control the electric parameters flowing in the electric circuits.

With reference to the rest of the figures, similar reference numerals have been used to identify similar parts.

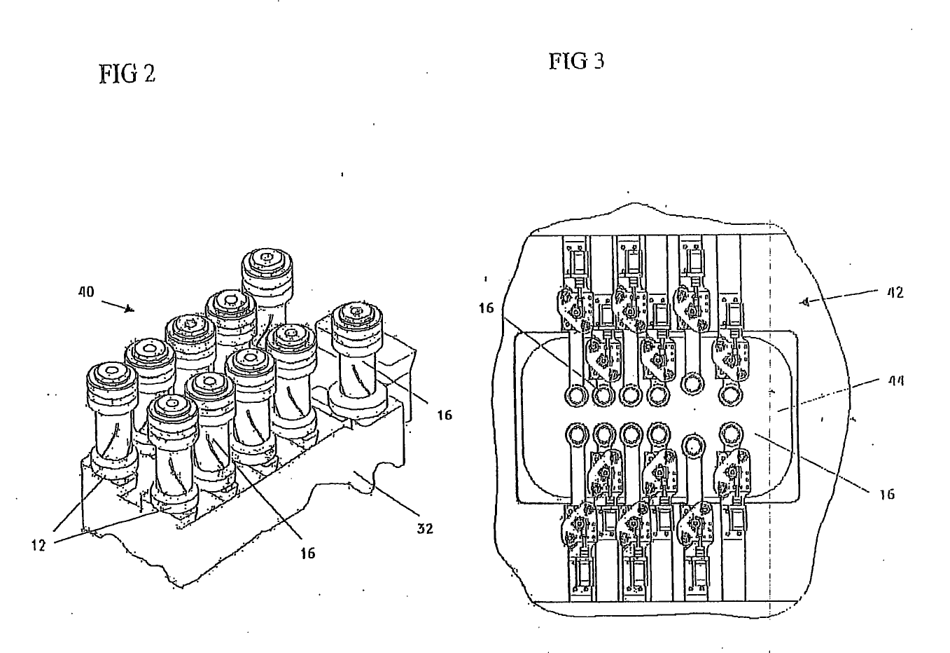

Referring now to FIG. 2, there is seen a cylinder-head casting 32, being treated by the use of a multi-head apparatus 40. The apparatus 40 is similar to the apparatus 10, described in FIG. 1, arranged for 10 first electrodes 16 each over a riser 12.

FIG. 3 illustrates a 12-electrodes embodiment 42, showing how closely the electrodes 16 can be spaced where many risers are necessary to produce a high quality casting 44.

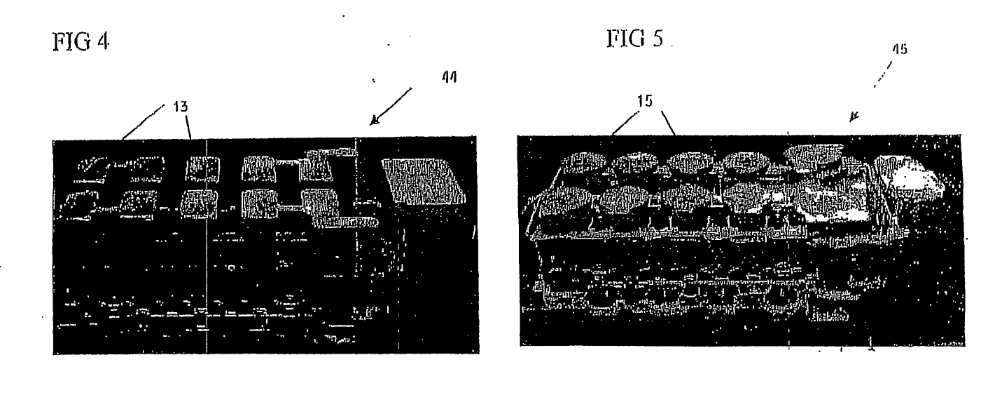

Seen in FIG. 4 is a photograph of an aluminum alloy cylinder head 44 weighing 36 kg which was produced by conventional casting, with 10 risers 13 of 14 kg.

FIG. 5 is a photograph 45 of the same size aluminum alloy cylinder head 45 treated by the method and apparatus of the present invention, with 10 smaller risers 15 of 4 kg.

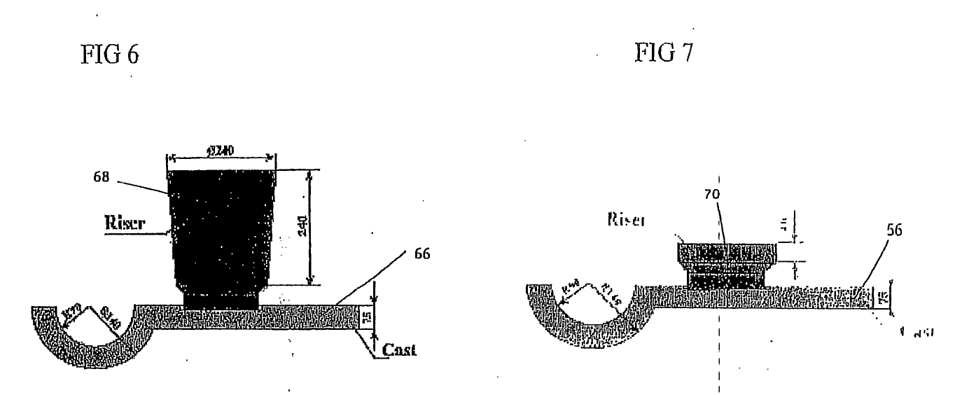

FIG. 6 shows a conventionally-cast shield casting 66 about 77 cm long, made of tool steel. Typical wall thickness is 50-75 mm. The casting 66 without the riser 68 weighs 170 kg, and was produced using a 240 mm diameter riser 68 which weighed 140 kg when discarded. By use of the apparatus 10 seen in FIG. 1 the same size 170 kg casting 56 was produced through the use of the much smaller riser 70 seen in FIG. 7. The riser 70 seen in

FIG. 7 when discarded weighed 26 kg, 19% of the riser 68 seen in FIG. 6.

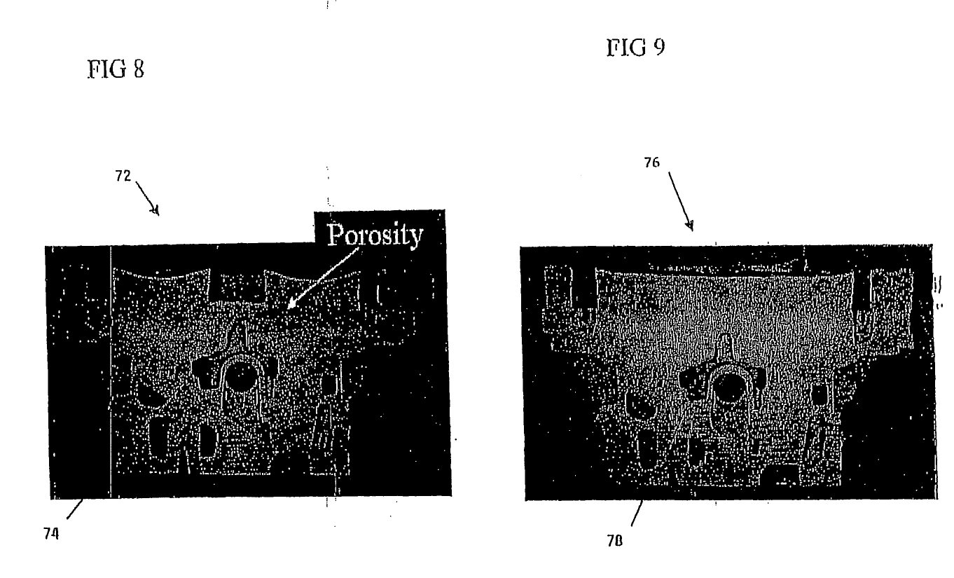

Seen in FIG. 8 is a photograph 72 of an aluminium alloy cylinder head slice 74 weighing 26 kg which was produced by conventional casting. Unacceptable porosity is seen in the upper section of the picture.

FIG. 9 is an photograph 76 of the same size aluminium alloy cylinder head slice 78 treated by the method and apparatus of the present invention. No porosity is evident in the photograph 76, due to the flowing/stirring action of the plasma arc

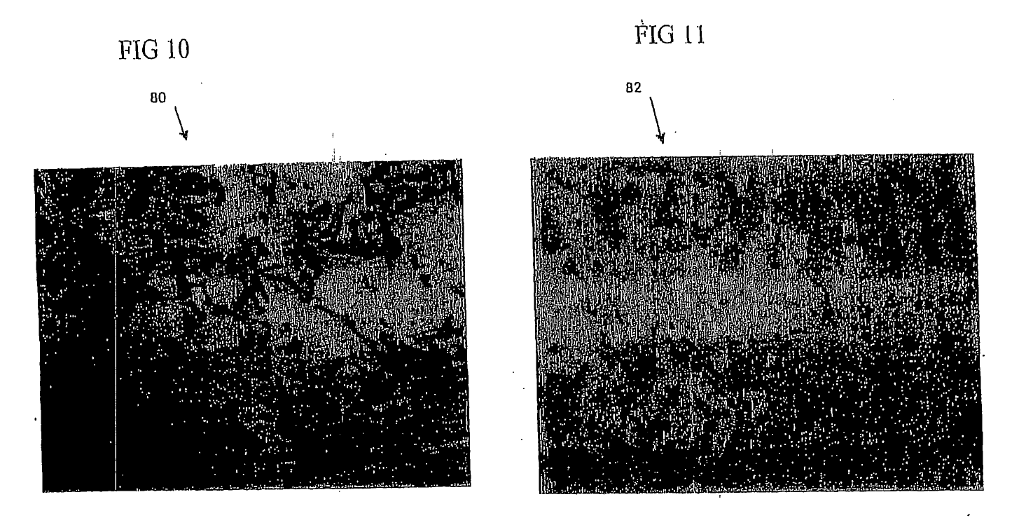

FIG. 10 is a microstructure photograph 80 of a sample fragment taken from an aluminium alloy casting, including 7% silicon, manufactured by conventional casting. The eutectic structure is coarse in comparison with FIG. 11.

FIG. 11 is a microstructure photograph 82 at the same magnification showing the microstructure of the same aluminium alloy taken from a casting treated by the method and apparatus of the present invention. The finer eutectic structure and improved homogeneity are evident.

The present invention also includes methods of producing the improved castings described, and in particular for achieving this while using dramatically smaller risers. The methods can be implemented using the apparatus described previously.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

We claim:

1. A metal casting apparatus for reducing the size of risers and/or improving quality in discrete metal castings, the apparatus comprising:
a) at least one plasma arc electrode for forming a continuously-moving plasma arc over the upper surface of at least one riser projecting above a metallic casting being cast in a mold;
b) at least one stand for suspending said at least one plasma arc electrode;
c) a second electrode attachable to a metallic surface of said mold being used for casting or to the cast metal, for completion of an electric circuit through metal cast in said mold to form a plasma arc; and
d) control means connected between said apparatus and a power supply and arranged to supply power to said plasma arc electrode(s) for completion of (an) electric circuit(s) including the molten metal in the mold for forming a continuously-moving plasma arc between the upper surface of each said riser and the lower face of the corresponding said first electrode, each plasma arc flowing/stirring the molten metal in a corresponding said riser, and controls connected between said apparatus and a power supply enabling control of the electric circuit(s).

2. A metal casting apparatus as claimed in claim 1 for improving quality of discrete metal castings for reducing voids, as defined, inclusions, porosity and grain size in said castings and for improving structure and homogeneity therein.

3. A metal casting apparatus as claimed in claim 1, wherein said castings are sand castings.

4. A metal casting apparatus as claimed in claim 1, wherein said castings are produced in permanent molds.

5. A metal casting apparatus as claimed in claim 1, wherein said castings are produced in semi-permanent molds.

6. A plasma casting apparatus substantially as described hereinbefore and with reference to the accompanying drawings.

7. A metal casting method for reducing the size of required risers, and/or improving quality of casting, said method comprising:
step a) casting a molten metal into a mold with a riser or risers thereabove;
step b) providing plasma arc electrode(s) and positioning same slightly above the upper surface of the molten metal in the riser(s); and
step c) connecting an electric potential to said electrode(s) to form a continually moving plasma arc, during the solidification process or part thereof between said electrode and the upper surface of said riser, so as to flow/stir said liquid metal in said riser(s),

8. A metal casting method as claimed in claim 7 for improving quality reducing voids, inclusions, porosity and grain size in produced castings and for improving homogeneity therein.

9. A casting method as claimed in claim 7, wherein said electric power applied to said electrode to form said plasma arc produces a current of at least 50 amperes.

10. A casting method, substantially as described hereinbefore and with reference to the accompanying drawings.
